(19) United States
(12) Patent Application Publication
(10) Pub. No.: US 2014/0136036 A1
(43) Pub. Date: May 15, 2014

(54) HYBRID VEHICLE

(71) Applicant: HONDA MOTOR CO., LTD., Tokyo (JP)

(72) Inventors: IORI KANAMORI, Utsunomiya-shi (JP); SATOSHI NAGASHIMA, Utsunomiya-shi (JP)

(73) Assignee: HONDA MOTOR CO., LTD., Tokyo (JP)

(21) Appl. No.: 14/075,752

(22) Filed: Nov. 8, 2013

(30) Foreign Application Priority Data
Nov. 12, 2012 (JP) 2012-248756

(51) Int. Cl. B60W 20/00; B60W 10/11; B60W 10/02; B60W 10/06; B60W 10/08

(52) U.S. Cl. CPC B60W 20/108; B60W 10/06; B60W 10/08; B60W 10/02; B60W 10/11; B60W 2600/00; Y10S 903/93
USPC 701/22; 180/65.265; 903/930

(57) ABSTRACT

A hybrid vehicle in which a forced charge area is set where vehicle travel is prohibited and a capacitor is charged by regenerating an electric motor with drive power of an internal combustion engine. The capacitor is charge in accordance with a temperature and charge amount of the capacitor. The forced charge area has a time-limited travel permission area in which predetermined vehicle travel is permitted up to a predetermined permitted amount of time, for vehicle travel using the internal combustion engine as a driving force source, and other vehicle travel during which the capacitor can be efficiently charged is permitted.

### CROSS REFERENCE TO RELATED APPLICATIONS

The present application claims priority under 35 U.S.C. §119 to Japanese Patent Application No. 2012-248756, filed on Nov. 12, 2012, entitled “Hybrid Vehicle,” the contents of which are incorporated herein by reference in their entirety.

### BACKGROUND

The present disclosure relates to a hybrid vehicle provided with an internal combustion engine and an electric motor as drive power sources.

In a hybrid vehicle with an internal combustion engine and an electric motor as drive power sources, a capacitor (e.g., a battery) supplies and receives electrical power to and from the electric motor. With such a hybrid vehicle, various arrangements are required when the output density of the capacitor drops at low and extremely low temperatures.

In one known hybrid vehicle, an internal combustion engine, an inverter circuit for a generator, and an inverter circuit for an electric motor are controlled, such that the vehicle travels using a required set driving force. When the engine is first started, the internal combustion engine is cranked and thereby started by the generator using at least rectangular-wave control.

Conventionally, hybrid vehicles are also known in which a forced charge area is set. In this forced charge area, vehicle travel is prohibited and the capacitor is charged by regenerating the electric motor by the drive power of the internal combustion engine, in accordance with the temperature and charge amount of the capacitor (hereinafter, also referred to as the state of charge (SOC)). By setting the forced charge area, a charge amount for normally operating a low-voltage accessory can be ensured, even if the output density of the capacitor has fallen.

However, if the vehicle is left overnight, after having been used to a low SOC through EV travel in a cold area, for example, and the capacitor or battery temperature the next day is extremely low, the capacitor state point will be within the forced charge area. The capacitor state point is determined in accordance with the temperature and charge amount of the capacitor. In this case, the user will have to wait until the forced charge of the capacitor is finished, since vehicle travel is prohibited.

In light of such problems, an aspect of the present disclosure is to provide a hybrid vehicle whereby a travelable area is broadened by allowing vehicle travel under specific conditions, even if the capacitor state point is within a forced charge area, and the required charge amount of the capacitor can be ensured.

### SUMMARY

According to a first aspect, a hybrid vehicle includes an internal combustion engine and an electric motor as driving force sources, a capacitor that supplies and receives electrical power to and from the electrical motor, and a control device capable of controlling operation of the internal combustion engine and the electrical motor in accordance with required driving force required to be produced in wheels. A forced charge area is set in which vehicle travel is prohibited and the capacitor is charged by regenerating the electric motor with drive power of the internal combustion engine, in accordance with a temperature and charge amount of the capacitor. The forced charge area has a time-limited travel permission area in which predetermined time-limited vehicle travel is permitted up to a predetermined permitted amount of time, for vehicle travel using the internal combustion engine as a driving force source, and other vehicle travel during which the capacitor can be efficiently charged is permitted.

With the first aspect, a time-limited travel permission area is provided in a forced charge area where vehicle travel during which the capacitor cannot be efficiently charged is permitted up to a predetermined amount of time, and vehicle travel during which the capacitor can be efficiently charged is permitted. In this time-limited travel permission area, a travel prohibition frequency can be reduced, while retaining a required minimum charge amount needed to drive a low-voltage accessory, even when a discharge restriction on the capacitor is needed. Therefore, the user can perform vehicle travel without having to wait for forced charging even if the capacitor state point, which is determined in accordance with the temperature and charge amount of the capacitor, is within the forced charge area.

A second aspect is the hybrid vehicle that also includes a clutch mechanism that controls power transmission between the internal combustion engine and the wheels by switching between an engaged state and a disengaged state. The time-limited vehicle travel is at least one of either reverse travel or extreme-low-speed travel in which the clutch mechanism is engaged in a middle position. With the second aspect, it is often the case in hybrid vehicles that charging of the capacitor is set so as to be done efficiently when rotation of the electric motor is in a forward direction (i.e., when the vehicle is traveling forward). Moreover, charge control becomes complex during extreme-low-speed travel in which the clutch mechanism is engaged in a middle position (a so-called half clutch). Therefore, if there is no extra charge amount, vehicle launch (during which turning around, or the like, is performed) is made possible by limiting reverse travel and/or extreme-low-speed travel, during which the capacitor cannot be charged efficiently, to within a predetermined amount of time.

A third aspect is the hybrid vehicle wherein the time-limited travel permission area is set only once when an ignition switch is initially turned on. With the third aspect, the usable range is broadened by an increase in the temperature of the capacitor during travel, and therefore by making a setting only once when the ignition switch is initially turned on, control can be prevented from becoming complex.

A fourth aspect is the hybrid vehicle wherein the time-limited travel permission area is set when a temperature of the capacitor is at or below a first temperature. With the fourth aspect, the drop in output of the capacitor in low temperatures can be handled.

A fifth aspect is the hybrid vehicle wherein the time-limited travel permission area is not set when a temperature of the capacitor is at or below a second temperature, which is lower than the first temperature. With the fifth aspect, the load on the capacitor can be suppressed by performing forced charging in an extreme-low-temperature area, which is an area during which discharging of the capacitor is significantly limited, without providing a time-limited travel permission area in the forced charge area.

A sixth aspect is the hybrid vehicle wherein the permitted amount of time for the time-limited vehicle travel is displayed within the time-limited travel permission area. With the sixth aspect, the user is notified of the permitted amount of time for reverse travel and/or extreme-low-speed travel in advance. Therefore, the user can be aware that reverse travel and/or extreme-low-speed travel is only possible within a limited amount of time, and thereby making it possible to encourage the user to drive in such a manner that travel does not become prohibited.

A seventh aspect is the hybrid vehicle wherein the permitted amount of time for the time-limited vehicle travel is reduced within the time-limited travel permission area. An eighth aspect is the hybrid vehicle wherein the permitted amount of time for the time-limited vehicle travel is not increased within the time-limited travel permission area even if the capacitor is charged. With the seventh and eighth aspects, consumption of the required minimum charge amount needed to drive the accessory can be avoided by reducing the permitted time for reverse travel and/or extreme-low-speed travel.

A ninth aspect is the hybrid vehicle wherein a notification is made that vehicle travel is no longer possible after the permitted amount of time for the time-limited vehicle travel has elapsed. With the ninth aspect, the user is notified that vehicle travel can no longer be performed after the permitted time in the time-limited travel permission area has elapsed, thereby making it possible for the user to be aware that vehicle travel will become possible after forced charging is finished.

A tenth aspect is the hybrid vehicle wherein electrical power is supplied to a low-voltage capacitor for a low-voltage accessory from at least one of either electrical power from the capacitor or regenerated electrical power from the electric motor. With the tenth aspect, electrical power is supplied to a low-voltage capacitor for a low-voltage accessory when the temperature is low or extremely low from at least one of either the electrical power from the capacitor or the regenerated electrical power from the electric motor. Therefore, electrical power must be supplied from the capacitor during vehicle travel during which the capacitor cannot be efficiently charged by the electric motor, meaning that a forced charge area is necessary. However, the frequency of travel prohibition can be reduced by providing the time-limited travel permission area.

An eleventh aspect is the hybrid vehicle wherein the permitted amount of time is changed according to how much the low-voltage accessory is used. With the eleventh aspect, the permitted time for the time-limited vehicle travel can be ensured for as long as possible by setting the permitted time in accordance with how much the low-voltage accessory is used.

A twelfth aspect is the hybrid vehicle wherein a travel management area for managing a travelable amount of time of at least either one of reverse travel or extreme-low-speed travel is set between a normal operation area, in which there are no restrictions on vehicle travel, and the time-limited travel permission area. The travelable amount of time is increased and decreased by charging/discharging of the capacitor within the travel management area. With the twelfth aspect, the desired vehicle travel can be permitted to the user while managing the charge amount. The travelable time for reverse travel and/or extreme-low-speed travel is increased and decreased by charging/discharging of the capacitor in a travel management area, within which there is a larger amount of charge than in the time-limited travel permission area.

A thirteenth aspect is the hybrid vehicle wherein a lower limit value of the normal operation area is set by taking into consideration the load produced by using the capacitor. With the thirteenth aspect, deviation in the polarized ions occurs due to use of the capacitor, resulting in greater resistance. Therefore, setting a lower limit value of a normal operation area, taking into account the load caused by this use, makes it possible to manage the charge amount accurately in accordance with the amount of use.

According to a fourteenth aspect, a hybrid vehicle includes an internal combustion engine that outputs mechanical drive power from an engine output shaft, an electric motor operable as a generator, and a capacitor that supplies and receives electrical power to and from the electrical motor. The hybrid vehicle also includes a first transmission mechanism that can receive mechanical drive power from the engine output shaft and the electric motor via a first input shaft, shift to one of a plurality of gears, and transmit the mechanical drive power to wheels; and a second transmission mechanism that can receive mechanical drive power from the engine output shaft via a second input shaft, shift to one of a plurality of gears, and transmit the mechanical drive power to wheels The hybrid vehicle further includes a first clutch that controls transmission of drive power between the engine output shaft and the first input shaft; a second clutch that controls transmission of drive power between the engine output shaft and the second input shaft; and a control device capable of controlling operation of the internal combustion engine and the electric motor. The control device is controlled in accordance with required driving force that is required to be produced in the wheels, selection of a gear in the first transmission mechanism and the second transmission mechanism, and selection of an engaged state and a disengaged state of the clutch mechanism constituted by the first clutch and the second clutch. A forced charge area is set in which discharge from the capacitor is prohibited, and the capacitor is charged by regenerating the electric motor with the drive power of the internal combustion engine, in accordance with a temperature and charge amount of the capacitor. The forced charge area has a time-limited travel permission area in which forward vehicle travel is permitted and predetermined vehicle travel is permitted up to a predetermined permitted amount of time, for vehicle travel using the internal combustion engine as a driving force source.

With the fourteenth aspect, a time-limited travel permission area is provided in a forced charge area where vehicle travel during which the capacitor cannot be efficiently charged is permitted up to a predetermined amount of time, and vehicle travel during which the capacitor can be efficiently charged is permitted. In this time-limited travel permission area, a travel prohibition frequency can be reduced, while retaining a required minimum charge amount needed to drive a low-voltage accessory, even when a discharge restriction on the capacitor is needed. Therefore, the user can perform vehicle travel without having to wait for forced charging even if the capacitor state point, which is determined in accordance with the temperature and charge amount of the capacitor, is within the forced charge area.

According to a fifteenth aspect, a capacitor charging control method is provided for a hybrid vehicle that includes an engine and a motor as drive power sources, a capacitor that supplies and receives power to and from the motor, and a control device capable of controlling operation of the engine and the motor in accordance with required driving force required to be produced in wheels. The method comprises acquiring a temperature and charge amount of the capacitor; setting a normal operation area by the control device, during which there are no restrictions on vehicle travel; and setting a forced charge area by the control device, during which vehicle travel is prohibited while the capacitor is charged by regenerating the motor with drive power of the engine. The method also includes setting a time-limited travel permission area in the forced charge area by the control device, during which time-limited vehicle travel when the capacitor cannot be efficiently charged is allowed up to a predetermined permitted amount of time, for vehicle travel using the engine as a driving force source, and during which other vehicle travel when the capacitor can be efficiently charged is permitted. The time-limited travel permission area is set when an ignition switch of the hybrid vehicle is initially turned on.

### BRIEF DESCRIPTION OF THE DRAWINGS

FIG. 1 is a block diagram illustrating a schematic configuration of a hybrid vehicle according to a first exemplary embodiment of the present disclosure.

FIG. 2 is a view illustrating an example driving control map in which a time-limited reverse permission area is not set.

FIG. 3 is a view illustrating an example driving control map in which a time-limited reverse permission area is set.

FIG. 4 is a flow diagram illustrating an example of the flow of control when an ignition switch is initially turned on.

FIG. 5 is a view illustrating a relationship between a remaining reverse permission time and one example of vehicle travel in a case where the time-limited reverse permission area is an area in which, in addition to reverse travel, extreme-low-speed travel is permitted up to a predetermined allowed time.

FIG. 6 is a skeleton diagram illustrating a schematic configuration of a hybrid vehicle according to a second exemplary embodiment of the present disclosure.

FIG. 7 illustrates an example of a drive power transmission pathway when the hybrid vehicle illustrated in FIG. 6 is engaged in reverse travel (engine reverse travel).

FIG. 8 illustrates an example of a drive power transmission pathway when the hybrid vehicle illustrated in FIG. 6 is regenerating the electric motor while in third-gear engine travel.

### DETAILED DESCRIPTION OF THE DISCLOSURE

Embodiments of the present disclosure are described below, with reference to the attached drawings.

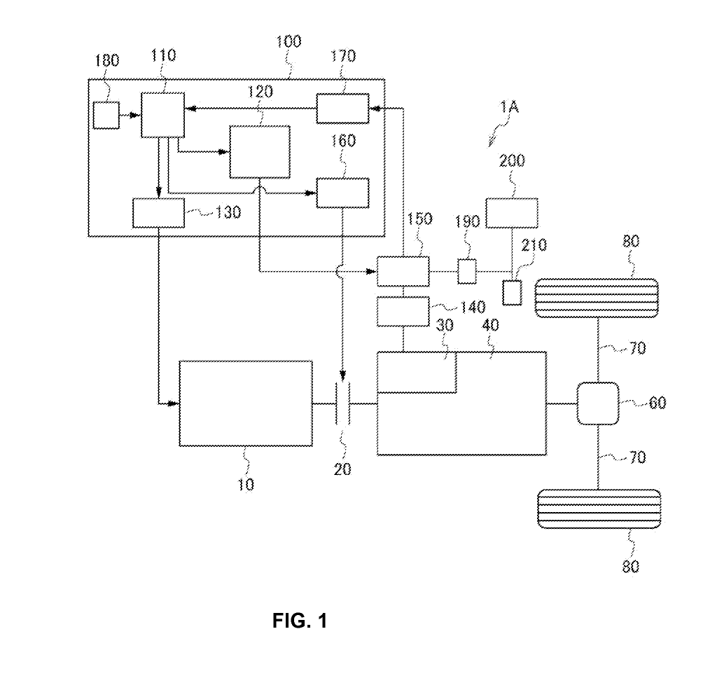

FIG. 1 is a view illustrating a configuration of a hybrid vehicle according to a first exemplary embodiment of the present disclosure.

A hybrid vehicle 1A (vehicle drive device) of this embodiment is provided with an internal combustion engine (e.g., an engine) 10 and an electric motor (e.g., a motor generator) 30 that produce torque that drives wheels 80. The hybrid vehicle includes a clutch mechanism 20 that can switch between an engaged state and a disengaged state and, when engaged, transmits via friction the torque produced by the internal combustion engine 10 to the wheels 80. The electric motor 30 is placed along the torque transmission pathway between the clutch mechanism 20 and the wheels 80 and is connected so as to allow supply and reception of electrical power to and from a capacitor 150 (e.g., battery). The hybrid vehicle 1A is further provided with a transmission mechanism 40 along the torque transmission pathway between the clutch mechanism 20 and the wheels 80. Output from the transmission mechanism 40 can be transmitted to the wheels 80 via a differential gear 60 and a driving force shaft 70. Note that the electric motor 30 may be incorporated into the transmission mechanism 40 or connected so as to allow transmission of drive power, to and from the transmission mechanism 40, separately from the transmission mechanism 40.

The hybrid vehicle 1A is also provided with a control unit or control device (e.g., electronic control unit (ECU)) 100 that controls the hybrid vehicle 1A. The control unit 100 may include, for example, a vehicle control unit 110, an electric motor control unit 120, an internal combustion engine control unit 130, a clutch mechanism control unit 160, a capacitor state acquisition unit 170, and a storage unit 180. The capacitor state acquisition unit 170 acquires the temperature and SOC of the capacitor 150.

The vehicle control unit 110 provides overall control of the vehicle in accordance with required torque from the user provided via an accelerator pedal (not illustrated) and the temperature and SOC of the capacitor 150 acquired by the capacitor state acquisition unit 170. For example, the vehicle control unit 110 determines a first torque command value to be produced in the internal combustion engine 10, a second torque command value to be produced in the electric motor 30, and an engage command or a disengage command for the clutch mechanism 20. The internal combustion engine control unit 130 controls the internal combustion engine 10 in accordance with the first command value. The electric motor control unit 120 controls an inverter 140 on the basis of the second torque command value. The clutch mechanism control unit 160 controls switching of the clutch mechanism 20 between an engaged state and a disengaged state in accordance with the engage command or the disengage command.

The inverter 140 controls the electric motor 30 in accordance with the second torque command value. More specifically, the inverter 140 drives the electric motor 30 such that the electric motor 30 outputs a torque corresponding to the second torque command value. The electric motor 30 operates as a motor that drives the wheels 80 using the electrical power supply from the capacitor 150 via the inverter 140, and also operates as a generator that converts rotation of a rotor in the electric motor 30 into electrical power. The electrical power produced by the electric motor 30 is extracted by the inverter 140 and stored in the capacitor 150.

The capacitor 150 is also connected via a step down transformer 190 to a low-voltage accessory 200 (e.g., an air conditioner, lights, communication equipment, and the like) and a low-voltage capacitor 210 (e.g., a 12 V battery) which have a drive voltage lower than the voltage of the capacitor 150. Accordingly, the low-voltage accessory 200 can be driven by receiving electrical power from the low-voltage capacitor 210 and the capacitor 150, as well as regenerated electrical power from the electric motor 30. Note, however, that the output from the low-voltage capacitor 210 drops at low temperatures, and particularly at extremely low temperatures, and therefore the low-voltage accessory 200 is driven substantially by receiving electrical power from the capacitor 150 and regenerated electrical power from the electric motor 30.

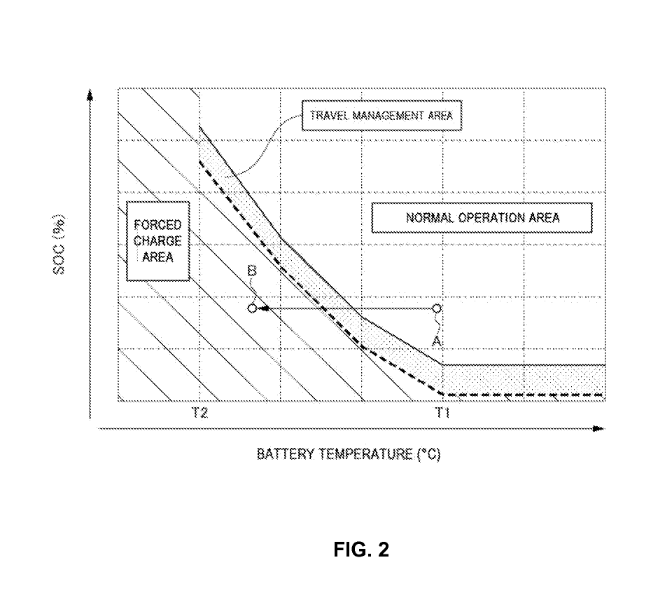

Further, the storage unit 180 of the control unit 100 stores a driving control map set in accordance with the temperature and SOC of the capacitor 150. As illustrated in FIG. 2, an example driving control map is divided into a normal operation area, a reverse management area (travel management area), and a forced charge area in accordance with the temperature and SOC of the capacitor 150. The vehicle control unit 110 controls the hybrid vehicle 1A on the basis of a capacitor state point, which is determined in accordance with the temperature and SOC of the capacitor 150 as acquired by the capacitor state acquisition unit 170.

The normal operation area is an area in which there is no problem with the SOC of the capacitor 150 in terms of vehicle travel. In this area, EV travel, during which the electric motor 30 is used as a driving force source, is allowed; and assistance or regeneration by the electric motor 30 during engine travel, during which the internal combustion engine 10 is used as a driving force source, is also allowed.

The output density of the capacitor 150 drops at or below a first temperature T1 (e.g., 0° C.), which is a low temperature. Therefore, the lower limit value of the normal operation area is set such that the SOC rises as the temperature falls in the area at or below the first temperature T1. Note that the lower limit value of this normal operation area is preferably set taking into account the load produced by use of the capacitor 150. Deviation in the polarized ions occurs due to use of the capacitor 150, resulting in greater resistance. Therefore, setting the normal operation area, taking into account the load caused by this use, makes it possible to manage the charge amount accurately in accordance with the amount of use.

The reverse management area is set to be an area in which the SOC is substantially uniformly several percentage points lower than the normal operation area. In this area, engine travel, in which the internal combustion engine 10 is used as a driving force source, is selected; and the capacitor 150 is charged by proactively regenerating the electric motor 30. Moreover, in this area, a reverse travelable time is managed. The reverse travelable time is managed in this manner because the inverter 140, and the like, is set such that charging of the capacitor 150 is done efficiently when rotation of the electric motor 30 is in a forward direction (i.e., when the hybrid vehicle 1A is traveling forward). Therefore, charging either cannot be done efficiently or sometimes cannot be done at all during reverse travel, creating a situation in which a sufficient charge amount for operating the low-voltage accessory 200 cannot be ensured if reverse travel is continued. Note that the range of the reverse management area is set such that a forced charge area described later is almost never entered into during ordinary reverse travel.

The forced charge area is the area other than the normal operation area and the reverse management area. The forced charge area is set to a temperature area at or below a second temperature T2 (e.g., from −30° C. to −40° C.), which is an extremely low temperature, irrespective of the SOC; and is also set to an area with an SOC lower than the reverse management area, in a temperature area at or above the second temperature T2. In this forced charge area, forced charging of the capacitor 150 is selected, and the user is prohibited from operating the vehicle until the forced charge is complete. By setting the forced charge area, a charge amount for normally operating the low-pressure accessory 200 can be ensured, even if the output density of the capacitor 150 has fallen.

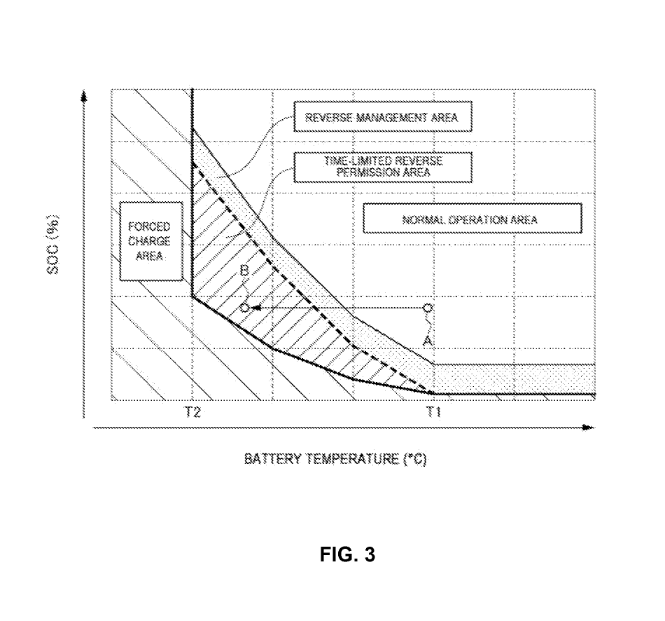

As illustrated in FIG. 3, when the ignition switch is initially turned on, a time-limited reverse permission area (time-limited travel permission area) is set in an area that has an SOC lower than in the reverse management area, in a temperature area from the first temperature T1 to the second temperature T2 of the forced charge area. The time-limited reverse permission area is not set in a temperature area lower than the second temperature T2. Note that the storage unit 180 may store two driving control maps, the driving control map illustrated in FIG. 2 and the driving control map illustrated in FIG. 3, or the storage unit 180 may store only the driving control map illustrated in FIG. 2, and the time-limited reverse permission area may be added to the driving control map illustrated in FIG. 2 when the ignition switch is initially turned on.

The time-limited reverse permission area is an area in which forward travel, which uses the internal combustion engine 10 as a driving force source, is permitted; and reverse travel, which uses the internal combustion engine 10 as a driving force source only up to a predetermined allowed time (e.g., 15 seconds), is permitted. This predetermined allowed time (permitted amount of time) is set such that a required minimum charge amount remains in order to operate the low-voltage accessory 200. A fixed value may be used, or the value may be varied in accordance with how much electrical power is used by the low-voltage accessory 200.

The effect of providing this time-limited reverse permission area only when the ignition switch is initially turned on is described below.

The time-limited reverse permission area is not set in the driving control map illustrated in FIG. 2. If the hybrid vehicle 1A is left overnight, after having been used in EV travel to a low SOC in a cold area (e.g., a capacitor state point A in FIG. 2), for example, and the capacitor or battery temperature the following day is an extremely low temperature (e.g., a capacitor state point B in FIG. 2), then the capacitor state point is within the forced charge area. The capacitor state point is determined in accordance with the temperature and charge amount of the capacitor 150. Therefore, the user is prohibited from operating the vehicle and must wait until the forced charge of the capacitor 150 is finished.

However, when the ignition switch is initially turned on, the user often drives forward, without reversing, or drives forward after reversing for a very short amount of time (e.g., when turning around). By traveling forward in the hybrid vehicle 1A, the required torque is output by the drive power of the internal combustion engine 10 and the electric motor 30 is regenerated, thereby making it possible to charge the capacitor 150. The temperature of the capacitor 150 also rises.

Accordingly, a time-limited reverse permission area is provided whereby, when the ignition switch is initially turned on, forward travel using the internal combustion engine 10 as a driving force source is permitted and reverse travel using the internal combustion engine 10 as a driving force source is permitted only up to a predetermined allowed time (e.g., 15 seconds). In this time-limited reverse permission area, a required minimum charge amount needed for driving the low voltage accessory 200 is retained, even if a discharge restriction on the capacitor 150 is needed, and a situation can be avoided in which the user is made to wait until the forced charge is finished due to travel prohibition.

The time-limited reverse permission area is set in the driving control map illustrated in FIG. 3. In this time-limited reverse permission area, even if the hybrid vehicle 1A is left overnight, after having been used in EV travel to a low SOC in a cold area (e.g., the capacitor state point A in FIG. 3), for example, and the capacitor or battery temperature the following day is an extremely low temperature (e.g., the capacitor state point B in FIG. 3), the capacitor state point is within the time-limited reverse permission area. Therefore, the user can drive forward, without reversing, or drive forward after an extremely short reverse travel for turning around or the like.

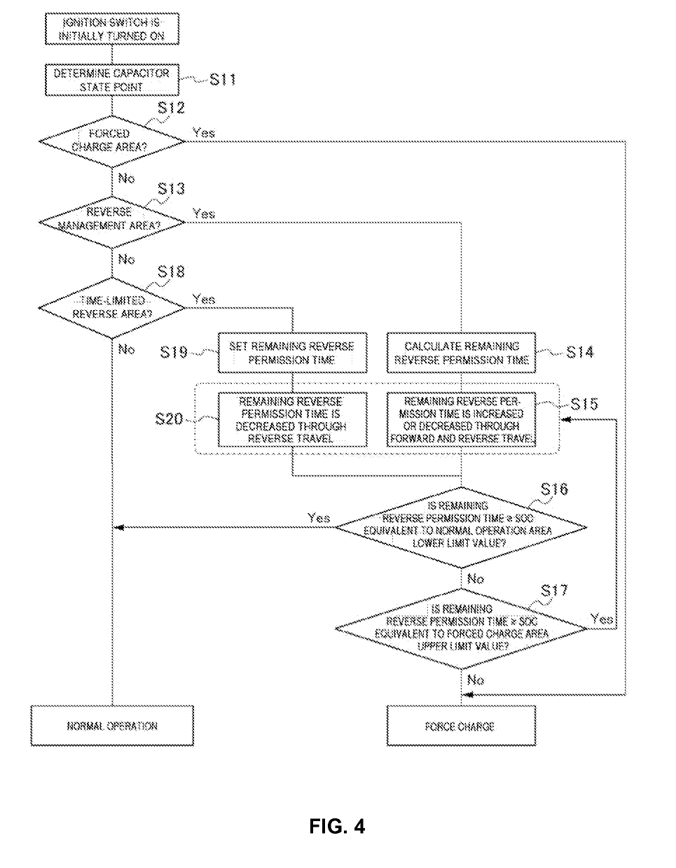

Next, an example control flow when the ignition switch is initially turned on is described with reference to FIG. 4.

First, the vehicle control unit 110 determines the capacitor state point, in accordance with the temperature and SOC of the capacitor 150 acquired by the capacitor state acquisition unit 170 (S11). Next, the vehicle control unit 110 compares the capacitor state point with the driving control map in which the time-limited reverse permission area is set, and determines whether or not the capacitor state point is in the forced charge area (S12). If, as a result, the capacitor state point is in the forced charge area, vehicle travel is prohibited and forced charging of the capacitor 150 is performed. If the capacitor state point is not in the forced charge area, the vehicle control unit 110 determines whether or not the capacitor state point is in the reverse management area (S13).

If, as a result, the capacitor state point is in the reverse management area, the vehicle control unit 110 calculates a remaining reverse permission time (travelable time), which is the amount of time during which reverse travel is possible (S14). In the reverse management area, the user can drive forward and reverse using the internal combustion engine 10 as a driving force source. If the capacitor 150 is charged by regenerating the electric motor 30 through forward travel, the remaining reverse permission time is increased. If the capacitor 150 is discharged through reverse travel, the remaining reverse permission time is decreased (S15). Note that the remaining reverse permission time in the reverse management area is not displayed to the user; rather, the user can freely select the driving mode.

Next, the vehicle control unit 110 determines whether or not the remaining reverse permission time is greater than or equal to an SOC equivalent to the lower limit value of the normal operation area, which is equivalent to the lower limit value of the normal operation area (S16). If, as a result, the remaining reverse permission time is greater than or equal to an SOC equivalent to the lower limit value of the normal operation area, the vehicle control unit 110 deems this to be the normal operation area and permits normal vehicle travel.

If the remaining reverse permission time is not greater than or equal to an SOC equivalent to the lower limit value of the normal operation area, then the vehicle control unit 110 next determines whether or not the remaining reverse permission time is greater than or equal to an SOC equivalent to the upper limit value of the forced charge area, which is equivalent to the upper limit value of the forced charge area (S17). If, as a result, the remaining reverse permission time is greater than or equal to the SOC equivalent to the upper limit value of the forced charge area, the process returns to step S15, where the remaining reverse permission time is increased or decreased through forward travel or reverse travel of the capacitor 150. If the remaining reverse permission time is not greater than or equal to the SOC equivalent to the upper limit value of the forced charge area, the vehicle control unit 110 deems this to be the forced charge area, vehicle travel is prohibited and the capacitor 150 is forced charged.

On the other hand, if, in step S13, the capacitor state point is not in the reverse management area, the vehicle control unit 110 determines whether or not the capacitor state point is in the time-limited reverse permission area (S18). If, as a result, the capacitor state point is in the time-limited reverse permission area, the vehicle control unit 110 sets a remaining reverse permission time (permitted amount of time), which is the amount of time during which reverse travel is possible (S19). In the time-limited reverse permission area, the remaining reverse permission time is indicated in a liquid crystal display of an indicator, for example. When the user drives in reverse, the remaining reverse permission time that is displayed in the indicator is decreased; and the remaining reverse permission time that is displayed is not increased even if the electric motor 30 is regenerated through forward travel, thereby charging the capacitor 150 (S20).

Note that the vehicle control unit 110 increases the remaining reverse permission time when the capacitor 150 is charged by regeneration of the electric motor 30 through forward travel, and then determines whether or not the remaining reverse permission time is greater than or equal to the SOC equivalent to the lower limit value of the normal operation area (S16). If, as a result, the remaining reverse permission time is greater than or equal to an SOC equivalent to the lower limit value of the normal operation area, the vehicle control unit 110 deems this to be the normal operation area and permits normal vehicle travel.

If the remaining reverse permission time is not greater than or equal to an SOC equivalent to the lower limit value of the normal operation area, then the vehicle control unit 110 next determines whether or not the remaining reverse permission time is greater than or equal to an SOC equivalent to the upper limit value of the forced charge area (S17). If, as a result, the remaining reverse permission time is greater than or equal to the SOC equivalent to the upper limit value of the forced charge area, the process returns to step S20, and if the user drives in reverse, the remaining reverse permission time displayed in the indicator is decreased. If the remaining reverse permission time is not greater than or equal to the SOC equivalent to the upper limit value of the forced charge area, the vehicle control unit 110 deems this to be the forced charge area, vehicle travel is prohibited and the capacitor 150 is forced charged. In this case, the user is alerted by the indicator to the fact that vehicle travel is no longer possible due to forced charging.

On the other hand, in step S18, if the capacitor state point is not in the time-limited reverse permission area, the vehicle control unit 110 deems this to be the normal operation area and permits normal vehicle travel.

Note that in the above embodiment, the time-limited reverse permission area is an area in which forward travel using the internal combustion engine 10 as a driving force source is permitted, and reverse travel using the internal combustion engine 10 as a driving force source is permitted only up to a predetermined allowed time (e.g., 15 seconds), but this is not a limitation. It is also possible for the time-limited reverse permission area to be an area in which reverse travel and/or extreme-low-speed travel is allowed for a predetermined allowed time, for vehicle travel using the internal combustion engine 10 as a driving force source, and other vehicle travel is allowed.

During extreme-low-speed travel, the driving force of the internal combustion engine 10 is too large, necessitating a so-called half clutch, in which the clutch mechanism 20 is engaged in a middle position. Attempting to charge the capacitor 150 in this state results in complex charge control. By permitting not just reverse travel but also extreme-low-speed travel up to a predetermined permitted time, since these types of travel are such that the charging cannot be done efficiently, charge control can be prevented from becoming too complex. Therefore, a required minimum charge amount needed for driving the low voltage accessory 200 is retained, even if a discharge restriction on the capacitor 150 is needed, and a situation can be avoided in which the user is made to wait until the forced charge is finished through travel prohibition.

If the time-limited reverse permission area is an area in which extreme-low-speed travel, and not just reverse travel, is permitted up to a predetermined allowed time, the remaining reverse permission time in steps S19 and S20 is an amount of time during which reverse travel and extreme-low-speed travel are possible. The remaining reverse permission time indicated in the liquid crystal display of the indicator is decreased when reverse travel or extreme-low-speed travel is performed. Similarly, the remaining reverse permission time in steps S14 and S15 is the amount of time during which reverse travel and extreme-low-speed travel area are allowed. This remaining reverse permission time is increased and decreased as the capacitor 150 is charged and discharged. The remaining reverse permission time in steps S16 and S17 is the remaining reverse permission time increased and decreased by the vehicle control unit 110.

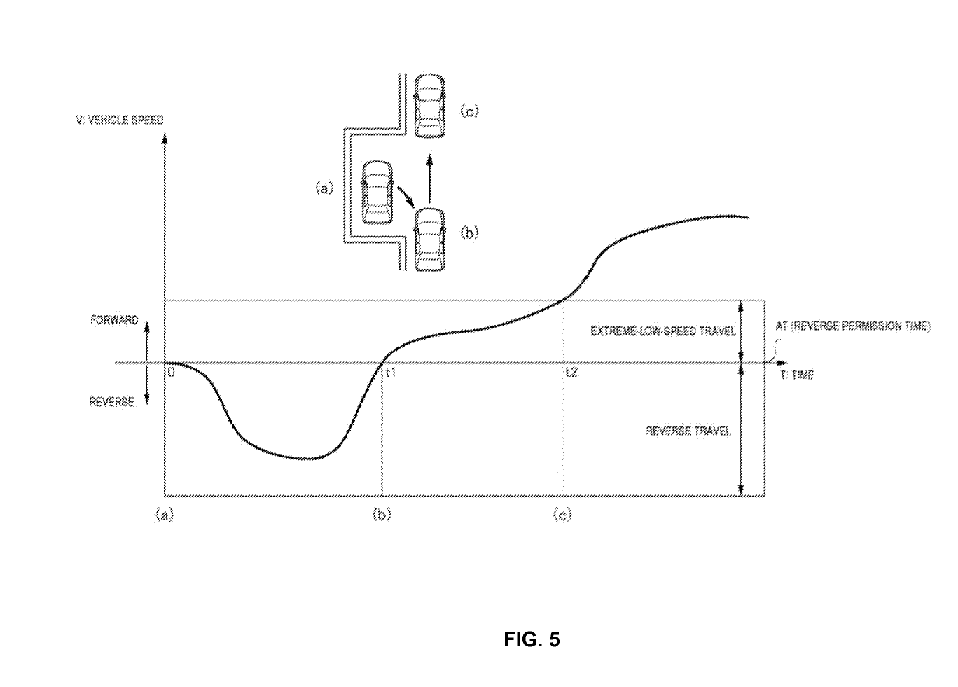

The remaining reverse permission time is now described, using as an example a case in which the capacitor state point is assumed to be in the time-limited reverse permission area. As illustrated in FIG. 5, the hybrid vehicle 1A reverses slightly, for example, from a stopped state (position (a) in the drawing) to the rear right (position (b) in the drawing), and then drives forward, launching the vehicle. In the drawing, extreme-low-speed travel is performed from position (b) to position (c).

In this case, the ignition switch is turned on and a reverse permission time AT is displayed in the liquid crystal display of the indicator, as the remaining reverse permission time. The user moves to position (b) in the drawing by reversing for time t1. When this happens, a time equal to AT−t1 is displayed in the liquid crystal display as the remaining reverse permission time. The user then moves to position (c) in the drawing by engaging in extreme-low-speed travel for time t2−t1. When this happens, a time equal to AT−t2 is displayed in the liquid crystal display as the remaining reverse permission time. Charging of the capacitor 150 is performed as the vehicle speed increases from position (c) in the drawing. Once the remaining reverse permission time increased by the vehicle control unit 110 is greater than or equal to the SOC equivalent to the lower limit value of the normal operation area, the remaining reverse permission time AT−t2 displayed is turned off.

As described above with the hybrid vehicle 1A, a time-limited travel permission area is provided in a forced charged area where vehicle travel during which the capacitor 150 can be efficiently charged is permitted, and vehicle travel during which the capacitor 150 cannot be efficiently charged is permitted up to a predetermined amount of time. In this time-limited travel permission area, the frequency of when vehicle travel is prohibited can be reduced, while retaining a required minimum charge amount needed to drive a low-pressure accessory 200, even when a discharge restriction on the capacitor 150 is needed. Therefore, the user can perform vehicle travel without having to wait for forced charging, even if the capacitor state point is within the forced charge area.

Note that with the hybrid vehicle 1A, the capacitor 150 is set so as to be charged efficiently when rotation of the electric motor 30 is in a forward direction (i.e., when the hybrid vehicle 1A is moving forward). Charge control becomes complex during extreme-low-speed travel in which the clutch mechanism 20 is engaged in a middle position (so-called half clutch). Accordingly, since the capacitor 150 cannot be charged efficiently during reverse travel and/or extreme-low-speed travel, reverse travel and/or extreme-low-speed travel are allowed up to a predetermined time in a time-limited travel permission area, but this is not a limitation.

By making the setting only once when the ignition switch is initially turned on, vehicle launch is possible for turning around, and the like, while retaining the required minimum charge amount needed for the low-voltage accessory 200. Because the usable range increases as the temperature of the capacitor 150 rises during travel, by making the setting only once when the ignition switch is turned on, it is possible to prevent control from becoming complex. However, the present disclosure is not necessarily limited only to when the ignition switch is initially turned on.

Further, because the time-limited travel permission area is set when the temperature of the capacitor 150 is at or below a first temperature, which is a low temperature, a drop in output by the capacitor 150 at a low temperature can be handled. In particular, even if the vehicle is left in a state of having been used to a low SOC in a cold area, and the capacitor or battery temperature the next day is a low temperature, the user can launch the vehicle can without having to wait for a forced charge.

The time-limited travel permission area is an extremely-low-temperature area at or above a second temperature. The time-limited travel permission area is an area in which discharging of the capacitor 150 is significantly limited, and in which forced charging is performed when a time-limited travel permission area is not provided to the forced charge area, making it thereby possible to suppress the load of the capacitor 150.

Further, the permitted amount of time for reverse travel and/or extreme-low-speed travel is displayed in the time-limited travel permission area, and the user can thereby be aware that reverse travel and/or extreme-low-speed travel are possible only within a limited amount of time. This displayed information makes it possible to encourage the user to drive in such a manner so as to avoid travel prohibition.

Moreover, by decreasing and not increasing the permitted amount of time for reverse travel and/or extreme-low-speed travel that is displayed in the time-limited travel permission area, even if the capacitor 150 is charged, ensures that the required minimum charge amount needed for driving the low-voltage accessory 200 can be prioritized. Note, however, that if a vehicle speed sufficient to efficiently charge the capacitor 150 is achieved, even during reverse travel, it is also possible to stop the decrease in the permitted time that is displayed or to increase the permitted time.

By notifying the user that vehicle travel can no longer be performed after the permitted time in the time-limited travel permission area has elapsed, the user can be made aware that vehicle travel will only become possible after forced charging is finished. Note that the permitted time may be a fixed or variable value. By changing the permitted time according to how much the low-voltage accessory 200 is used, a permitted time for limited reverse travel and/or extreme-low-speed travel can be ensured for as long as possible.

Further, in the driving control map, a travel management area is located between a normal operation area where there is no limitation on vehicle travel and the time-limited travel permission area. In this travel management area, the travelable time for vehicle travel is increased and decreased due to charging and discharging of the capacitor 150, thereby making it possible to permit the user to undertake desired vehicle travel while managing the charge amount of the capacitor 150.

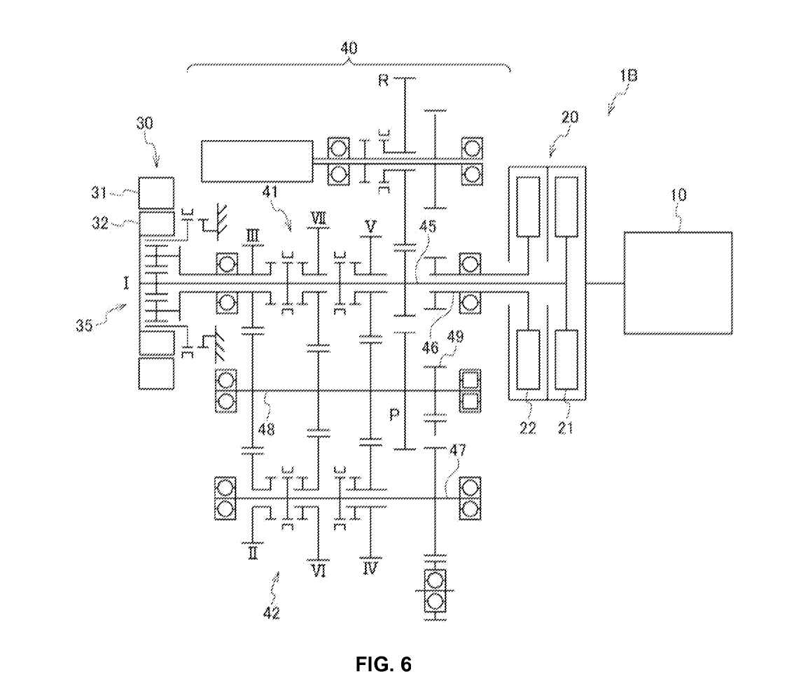

Next, a hybrid vehicle 1B (vehicle drive device) according to a second exemplary embodiment of the present disclosure is described with reference to FIG. 6.

FIG. 6 is a skeleton diagram illustrating a schematic configuration of a hybrid vehicle according to the second embodiment of the present disclosure, in which specific configurations of the clutch mechanism 20, the electric motor 30, and the transmission mechanism 40 of the hybrid vehicle 1A of the first embodiment are illustrated. In FIG. 6, “I,” “II,” “III,” “IV,” “V,” “VI,” “VII,” and “R” indicate transmission pathways for first to seventh and reverse gears.

The electric motor 30 may be a three-phase brushless DC motor, for example. This three-phase brushless DC motor has a stator 31, which includes an armature, on the outside and a rotor 32, which includes a permanent magnet, on the inside. The transmission mechanism 40 may include a first transmission mechanism 41 that transmits to the wheels 80 torque produced by the internal combustion engine 10 and torque produced by the electric motor 30, and a second transmission mechanism 42 that transmits to the wheels 80 torque produced by the internal combustion engine 10. The clutch mechanism 20 includes a first clutch 21 that transmits to the first transmission 41 torque produced by the internal combustion engine 10, and a second clutch 22 that transmits to the second transmission 42 torque produced by the internal combustion engine 10. A mechanism provided with two clutches and two transmissions is called a double clutch transmission.

The input side of the clutch mechanism 20 including the first clutch 21 and the second clutch 22 is linked to an engine output shaft of the internal combustion engine 10. The output side of the first clutch 21 is connected to a first end of a first main shaft (first input shaft) 45, and the output side of a second clutch 22 is connected to a first end of a second main shaft (second input shaft) 46. A sun gear of a planetary gear mechanism 35 that has the sun gear, a planetary gear, a ring gear, and a carrier is connected to a second end of the first main shaft 45. The rotor 32 of the electric motor 30 is linked to the sun gear. A first-and-third speed drive gear, a fifth speed drive gear, and a seventh speed drive gear (i.e., the gears for the odd-numbered speeds), which are linkable to the first main shaft 45 and constitute the first transmission 41, are disposed around the first main shaft 45 concentrically with the first main shaft 45. The first-and-third speed drive gear is linked to the carrier of the planetary gear mechanism 35 via a hollow shaft.

Rotation of the second main shaft 46 is transmitted to an intermediate shaft 47 via an idling gear. A second speed drive gear, a fourth speed drive gear, and a sixth speed drive gear (i.e., the gears for the even-numbered speeds), which are linkable to the intermediate shaft 47 and constitute the second transmission 42, are disposed around the intermediate shaft 47 concentrically with the intermediate shaft 47. Rotation of the first main shaft 45 and rotation of the second main shaft 46 are selectively transmitted to a counter shaft 48 via these drive gears. Rotation of the counter shaft 48 can be transmitted from the output gear 49 through a differential gear 60 and a drive shaft 70 to the wheels 80 (see FIG. 1). Note that in FIG. 6, the reference numeral P indicates a parking gear.

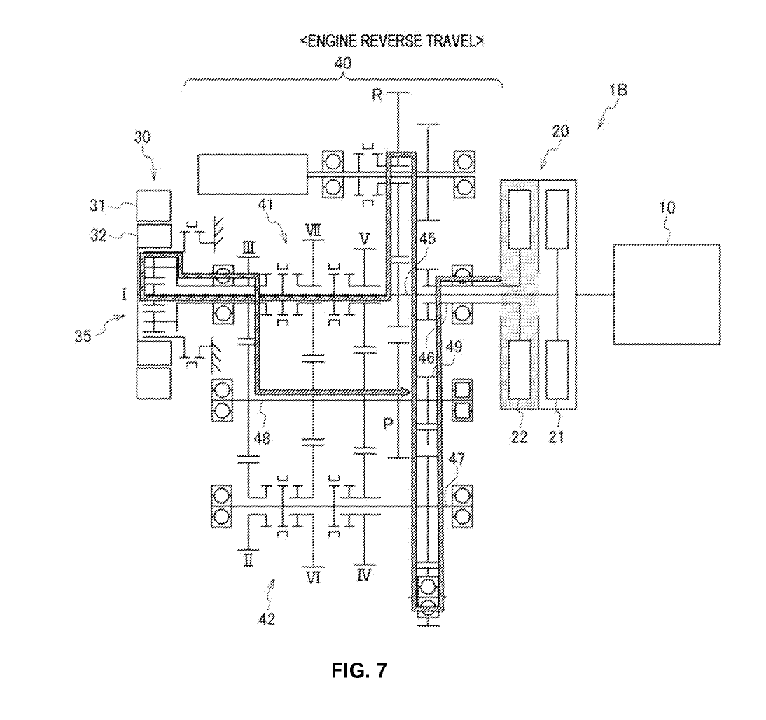

FIG. 7 illustrates a drive power transmission pathway of a state in which a reverse gear is selected in the hybrid vehicle 1B, which is provided with a double clutch transmission, and reverse travel (engine reverse travel) is being performed.

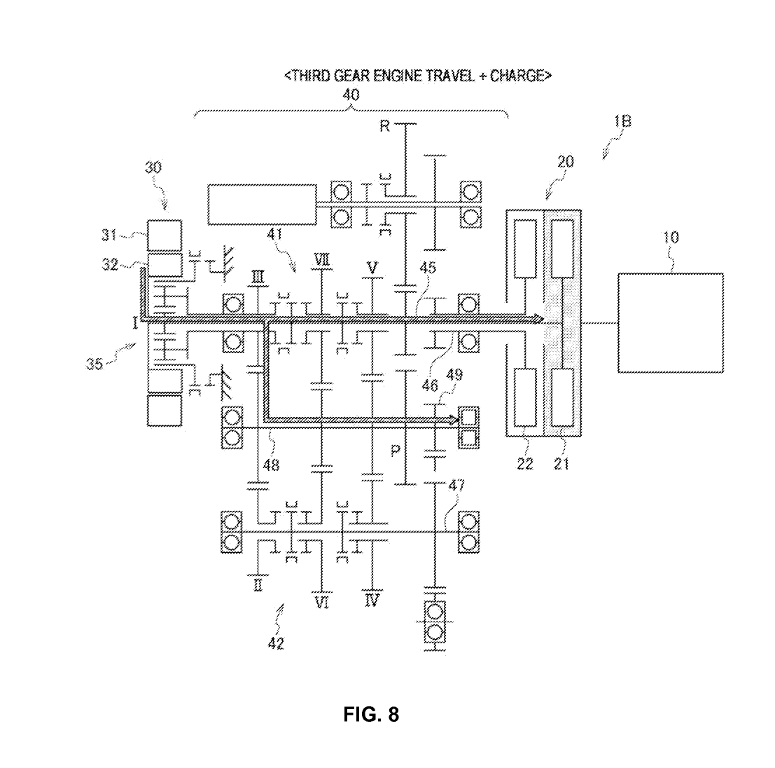

FIG. 8 illustrates a drive power transmission pathway in a case in which the capacitor 150 is being charged as the electric motor 30 is regenerated while in third-gear engine travel. Note that the capacitor 150 can be charged while driving forward by selecting any shift position, and not just third speed.

Note that the present disclosure is not limited to the embodiments described above, and appropriate modifications, enhancements, or the like, are possible. This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A hybrid vehicle, comprising:
an internal combustion engine and an electric motor as drive power sources;
a capacitor that supplies and receives electrical power to and from the electric motor; and
a control device capable of controlling operation of the internal combustion engine and the electric motor in accordance with required driving force required to be produced in wheels,
a forced charge area being set in which vehicle travel is prohibited and the capacitor is charged by regenerating the electric motor with drive power of the internal combustion engine, in accordance with a temperature and charge amount of the capacitor,
the forced charge area having a time-limited travel permission area in which predetermined time-limited vehicle travel is permitted up to a predetermined permitted amount of time, for vehicle travel using the internal combustion engine as a driving force source, and other vehicle travel during which the capacitor can be efficiently charged is permitted.

2. The hybrid vehicle according to claim 1, further comprising a clutch mechanism that controls transmission of drive power between the internal combustion engine and the wheels by switching between an engaged state and a disengaged state, and
the time-limited vehicle travel being at least one of either reverse travel or extreme-low-speed travel in which the clutch mechanism is engaged in a middle position.

3. The hybrid vehicle according to claim 1, wherein the time-limited travel permission area is set only once when an ignition switch is initially turned on.

4. The hybrid vehicle according to claim 1, wherein the time-limited travel permission area is set when a temperature of the capacitor is at or below a first temperature.

5. The hybrid vehicle according to claim 4, wherein the time-limited travel permission area is not set when a temperature of the capacitor is at or below a second temperature, which is lower than the first temperature.

6. The hybrid vehicle according to claim 2, wherein the permitted amount of time for the time-limited vehicle travel is displayed within the time-limited travel permission area.

7. The hybrid vehicle according to claim 6, wherein the permitted amount of time for the time-limited vehicle travel that is displayed is reduced within the time-limited travel permission area.

8. The hybrid vehicle according to claim 7, wherein the permitted amount of time for the time-limited vehicle travel that is displayed is not increased within the time-limited travel permission area even if the capacitor is charged.

9. The hybrid vehicle according to claim 6, wherein a notification is made that vehicle travel is no longer possible after the permitted amount of time for the time-limited vehicle travel has elapsed.

10. The hybrid vehicle according to claim 1, wherein electrical power is supplied to a low-voltage capacitor for a low-voltage accessory from at least one of either electrical power from the capacitor or regenerated electrical power from the electric motor.

11. The hybrid vehicle according to claim 10, wherein the permitted amount of time is changed according to how much the low-voltage accessory is used.

12. The hybrid vehicle according to claim 2, wherein a travel management area is set in which a travelable amount of time of at least either one of reverse travel or extreme-low-speed travel is managed between a normal operation area, in which there are no restrictions on vehicle travel, and the time-limited travel permission area; and
the travelable amount of time is increased and decreased by charging/discharging of the capacitor within the travel management area.

13. The hybrid vehicle according to claim 12, wherein a lower limit value of the normal operation area is set by taking into consideration load produced by using the capacitor.

14. A hybrid vehicle, comprising:
an internal combustion engine that outputs mechanical drive power from an engine output shaft;
an electric motor that can operate as a generator;
a capacitor that supplies and receives electrical power to and from the electric motor;
a first transmission mechanism that can receive mechanical drive power from the engine output shaft and the electric motor via a first input shaft, shift to one of a plurality of gears, and transmit the mechanical drive power to wheels;
a second transmission mechanism that can receive mechanical drive power from the engine output shaft via a second input shaft, shift to one of a plurality of gears, and transmit the mechanical drive power to the wheels;
a first clutch that controls transmission of drive power between the engine output shaft and the first input shaft;
a second clutch that controls transmission of drive power between the engine output shaft and the second input shaft; and
a control device capable of controlling operation of the internal combustion engine and the electric motor in accordance with required driving force which is required to be produced in the wheels, selection of a gear in the first transmission mechanism and the second transmission mechanism, and selection of an engaged state and a disengaged state of a clutch mechanism comprising the first clutch and the second clutch,
a forced charge area being set in which discharge from the capacitor is prohibited and the capacitor is charged by regenerating the electric motor with the drive power of the internal combustion engine, in accordance with a temperature and charge amount of the capacitor,
the forced charge area having a time-limited travel permission area in which forward vehicle travel is permitted and predetermined vehicle travel is permitted up to a predetermined permitted amount of time, for vehicle travel using the internal combustion engine as a driving force source.

15. The hybrid vehicle according to claim 14, wherein the capacitor can be efficiently charged during the forward vehicle travel, and the capacitor cannot be efficiently charged during the predetermined vehicle travel.

16. The hybrid vehicle according to claim 14, wherein the predetermined vehicle travel is at least one of either reverse travel or extreme-low-speed travel in which the clutch mechanism is engaged in a middle position.

17. A capacitor charging control method for a hybrid vehicle, said hybrid vehicle comprising an engine and a motor as drive power sources, a capacitor that supplies and receives power to and from the motor, and a control device capable of controlling operation of the engine and the motor in accordance with required driving force required to be produced in wheels, said method comprising:
acquiring a temperature and charge amount of the capacitor;
setting a normal operation area by the control device, during which there are no restrictions on vehicle travel;
setting a forced charge area by the control device, during which vehicle travel is prohibited while the capacitor is charged by regenerating the motor with drive power of the engine; and
setting a time-limited travel permission area in the forced charge area by the control device, during which time-limited vehicle travel when the capacitor cannot be efficiently charged is allowed up to a predetermined permitted amount of time, for vehicle travel using the engine as a driving force source, and during which other vehicle travel when the capacitor can be efficiently charged is permitted,
wherein the time-limited travel permission area is set when an ignition switch of the hybrid vehicle is initially turned on.

18. The method of claim 17, wherein the time-limited travel permission area is at least one of either reverse travel or extreme-low-speed travel.

19. The method of claim 17, further comprising setting a travel management area by the control device, during which a travelable amount of time of at least either one of reverse travel or extreme-low-speed travel is managed between the normal operation area and the time-limited travel permission area, wherein the travelable amount of time is increased and decreased by charging and discharging of the capacitor within the travel management area.

20. The hybrid vehicle according to claim 17, wherein power is supplied to a low-voltage capacitor for a low-voltage accessory from at least one of either power from the capacitor or regenerated power from the motor, and the permitted amount of time is changed according to how much the low-voltage accessory is used.
